(19) United States
(12) Patent Application Publication
(10) Pub. No.: US 2015/0081317 A1
(43) Pub. Date: Mar. 19, 2015

(54) Instant Mobile Practice

(71) Applicant: David Evgey, Pikesville, MD (US)

(72) Inventor: David Evgey, Pikesville, MD (US)

(21) Appl. No.: 14/028,694

(22) Filed: Sep. 17, 2013

(51) Int. Cl. G06F 19/00

(52) U.S. Cl. CPC G06F 19/3418
USPC 705/2

(57) ABSTRACT

Enabling communication for a health service provider through a mobile device that includes receiving a request for real-time communication with a health service provider through a mobile device, prompting the consumer to choose a network and thus, the system generating a choice of operations. The consumer then makes a choice such as private communication request and scheduling an appointment through the mobile device. The chosen operation is performed based on the choice by the consumer.

### FIELD OF TECHNOLOGY

This disclosure relates generally to instant mobile practice and, more particularly, enabling remote communication between a patient and a health care provider or a group and other health related service providers such health insurance companies.

### BACKGROUND

The numbers of patients seeking has been increasing a rapid rate. The rapid increase in number of patients has not been matched in the number of doctors and health service providers being trained to provide health care.

On Mar. 23, 2010 President Obama signed into law “The Patient Protection and Affordable Act”. The patient protection and affordable act reform may add over 30 million new insured patients without increasing the number of health professionals needed to provide care to the newly insured patients.

Traditional means of delivering health care will not suffice to meet ever increasing patient needs. Alternative means to reach patients and prove health care are increasingly the need of the hour.

Definitions

SeeDocNow Network-private and secure online communication entity that serves only the members subscribed to it.

There two type of SeeDocNow networks: Public network for hospitals and health insurance companies and employers and provider network for a solo provider.

Licensee-The provider or health organization licensing the IMP technology.

Staff Member: individuals who are employed by the Licensee such as nurses and others.

Panel: private, secure and HIPPA compliant for. Used for holding conversations and for the exchange of medical files and photos. Panel creator, either a provider or a patient, can invite and subscribe to the panel any number of care givers patients and family members.

User-general term for the person who use the system regardless of their function. They could be a doctor, staff member or a patient.

### SUMMARY

Disclosed are a method, an apparatus and/or a system of an instant mobile practice. In one aspect, a method of mobile device enabling communication for a health service provider. The method includes receiving a request from a Licensee (health organization or a single provider) through the mobile device for the creation of a mobile secure private network for, real-time communication with a health service provider and/or staff members. Further, the Licensee is prompted to choose one of a public network and provider network, a choice of operations is generated. The Licensee makes a choice among the choice of operations and the choice made is received. A chosen operation is performed based on the choice by the consumer. Based on the response of the licensee the network is created. This process of setting up the network is a one tine process.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a diagrammatic representation of a data processing system, according to one or more embodiments.

FIG. 2 is a process flow diagram detailing the operation of an IMP, according to one or more embodiments.

FIG. 3 is a system diagram of an IMP system, according to one or more embodiments.

FIG. 4 is a flow diagram detailing the operations of an IMP system, according to one or more embodiments.

FIG. 5 is a Screen shot of Public network

FIG. 6 is a Screen Shot of Provider network

FIG. 7 is a Screen shot of list of panels in a network

FIG. 8 is a Screen shot of the Lobby

FIG. 9 is a Screen shot of panel properties

Other features of the present embodiments will be apparent from the accompanying drawings and from the detailed description that follows.

### DETAILED DESCRIPTION

Example embodiments, as described below, may be used to provide a method, an apparatus and/or a system of instant mobile practice. Although the present embodiments have been described with reference to specific example embodiments, it will be evident that various modifications and changes may be made to these embodiments without departing from the broader spirit and scope of the various embodiments.

In one or more embodiments, instant mobile practice (IMP) may be defined as technology behind a mobile application and service that creates a private mobile application under the brand name of a health service provider and/or a network.

In one or more embodiments, IMP may enable its users to locate a doctor or a provider and receive medical consultation and second opinions for various medical issues.

In one or more embodiments, IMP may create a secure, private and health insurance portability and accountability act (HIPAA) compliant network under the brand name of a health service provider by just filling a single form.

In one or more embodiments, IMP may create a private secure network for collaboration and defines who will collaborate with whom. Further, Patients for example may communicate only with dedicated staff members such as doctors, administrative staff of health service provider and so on. The health service providers, and their staff however, may be able to communicate and collaborate with any and all patients in the private secure network. For maximum flexibility IMP enables the Licensee to change the default option and enable patients, users of the service, to collaborate with each other. The communication may be in form of private secure HIPAA compliant chat seamlessly integrated with a mobile cross platform video conferencing.

There may be two types of organizations that are defined as health service providers: Solo practice or a single provider and the second is a health organization employing multiple providers.

In one or more embodiments, a typical patient may face the challenge of coordinating his/her care among multiple health service providers. The health service providers may operate under tremendous time pressure and resources constraints. Then number of patients and doctors are both not increasing at the same rate. Increase in the number of patients far exceeds the speed with which new doctors are being trained for society. Thus the merit of the system for patients to coordinate care giving with multiple providers and let them collaborate at their own pace and tempo.

In an example embodiment, IMP may enable the patient to create a private and secure panel or a chat room and invite a cardiologist, radiologist, nutritionist, family physician and supporting family members to view medical images and post their comments or diagnosis to that chat room, placing, in the process all care givers to work in tandem and address health issues.

In one or more embodiments, a Licensee may fill an initial form which includes uploading photo or a logo. The licensee may gain access to the IMP system by acquiring a license. IMP system may then the consumer to choose between two options:

a. Create a Public Network

b. b. Create a provider Network

In one or more embodiments, Public network may be for health organizations, hospitals associations and self-insured employers. Health organizations, hospitals associations or self-insured employers may license IMP to be used by patients associated with the health organizations, hospitals associations or self-insured employers.

In one or more embodiments, IMP may manage information about health service providers. IMP may identify a search term for a network and enables user to find health service providers affiliated with and/or approved by a health network, group, hospital or self-insured employer. Each network may provide access to resources. Resources may be a list of links to useful information such as videos, forms, surveys, web content selected by the health service provider. IMP may authorized a consumer to manage resources. Accordingly, IMP may place the appropriate button to manage resources.

In one or more embodiments, IMP may include secured panels. IMP may enable a patient to create private and secure chat room and/or a panel and invite others for chat and collaboration. Being aware of the type of consumer, if the consumer is defined as an admin IMP may make the entire directory of all consumers users of that network available. In case the consumer is identified as a patient, a host of plans made available to patients may be shown to the consumer.

In one or more embodiments, provider network may refer to solo practitioners or physicians, dentists or other health service providers. In one or more embodiments, the purpose of provider networks may be to provide patients with easy access to health service providers and their staff members and coordinate care among multiple care providers.

In one or more embodiments, in order to join a provide network, a User may enter a code given by health service provider to join the provider network.

In an example embodiment, the system enables the patients, the user of the service to join Purchasing groups for buying medications , medical devices, and other health related services and products. For example a user who suffers from diabetes will be able, at his/her consent, to join a purchasing group for buying diabetes supplies for a deep discount. Once the patient is interested to purchase the product or service, IMP issues an SDN code which enables the patient to purchase the product or service at a discount price.

In an example embodiment, a patient may schedule an appointment. Consumer may view available dates and time slots available for scheduling an office visit, phone or video online meeting. Upon the patient's selection of best time and date and after the consumer fills a form that includes one of the reason for the visit, type of visit and insurance information, IMP may generate a panel chat room and invites to that panel the patient requesting the meeting and staff member(s) necessary for the scheduling as defined by the provider.

In an example embodiment, communication about a meeting will be handled on a chat room created for the purpose. When both parties agree on time and date, IMP may send an email message and saves the meeting in the calendar.

In one or more embodiments, IMP identifies the user and if the user is defined as authorized to manage scheduling, IMP may place the appropriate button to manage available dates and times, how long each time slot is valid for, days in which the provider does not work and so on.

In one or more embodiments, due a closed nature of communication between patients and health service providers and the need to maintain maximum privacy, IMP may create a special network called lobby. In the Lobby, providers and patients across organizations may collaborate without any limits.

Another use of the Lobby is to list all incoming messages from all networks and providers associated with IMP. Upon the consumer tapping on a message an actual interaction happens automatically in the designated private network where it was originally created.

In one or more embodiments, chat form may be referred to as technology developed to collect data from chat and save it to databases. In the course of using the chat people may exchange free text information back and forth. In a panel of a user interface provided to a user of the IMP system for the secure chat room of IMP system, a user may type using free text, and/or a question. The user may mark the beginning and end of text as an indication for IMP to mark that text as question and be saved on special database. The question may be plain text such as asking the recipient to express their opinion on a subject or insurance information or prompt the user to select an answer from multiple choice answers such rate their satisfaction from a service. Users of the IMP system may be members of panel who receive the question may tap on it to enter an answer. If the user has answered the question before, IMP may display that answer and let member of the panel enter a new answer. Only questions are visible to panel members (participating in the chat room). The answers, however , are saved to remote databases, will not visible to panel members is not The answer may be saved to a computer database and further saved to a downloadable file with answers from all users.

In one or more embodiments, when a recipient of a message through chat form taps on that message, the consumer may be prompted to enter an answer. The answer may be transmitted to central server along with the following information:

Name of the panel :

User Name:

Question number: (there is no limit to the number of questions)

Answer:

In an example embodiment, the answer could be free text, selection of one or more options from a list, and selection of multiple choices. The chat form may be broadcasted to multiple number of users. Chat Form may be a powerful way to collect data from people on the go for the purpose of market research, collect missing information such as insurance information, allergies, emergency contacts, conditions or survey patients about satisfaction.

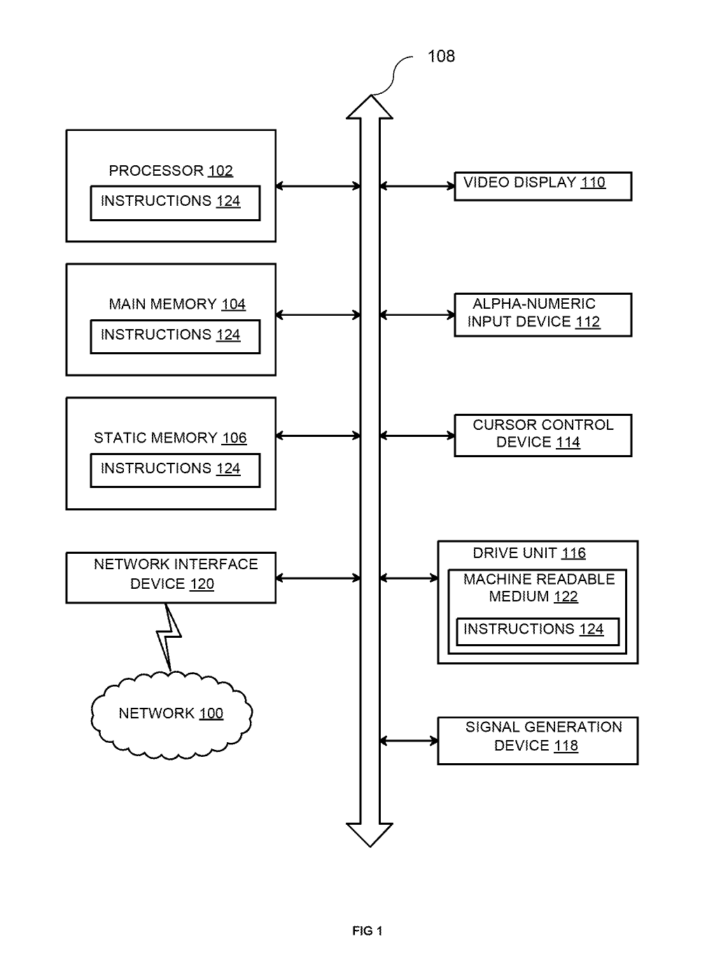

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 within which a set of instructions, for causing the machine to perform any one or more of the methodologies discussed herein, may be executed. In various embodiments, the machine operates as a standalone device and/or may be connected (e.g., networked) to other machines

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 126 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

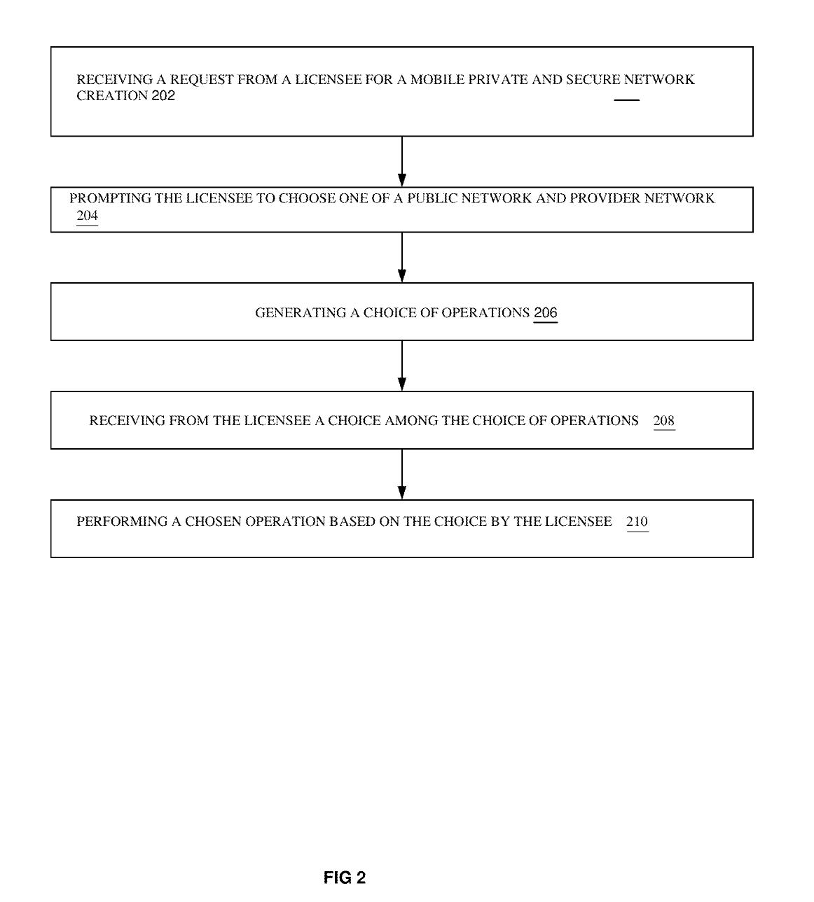

FIG. 2 is a process flow representing the method of a computer-implemented method of mobile device enabling communication for a health service provider that may include the steps of receiving a request from a consumer through the mobile device for an electronic, real-time communication with a health service provider 202, prompting the consumer to choose one of a public network and provider network 204, generating, by one or more computers, a choice of operations 206, receiving from the consumer a choice among the choice of operations 208 and performing a chosen operation based on the choice by the consumer 210.

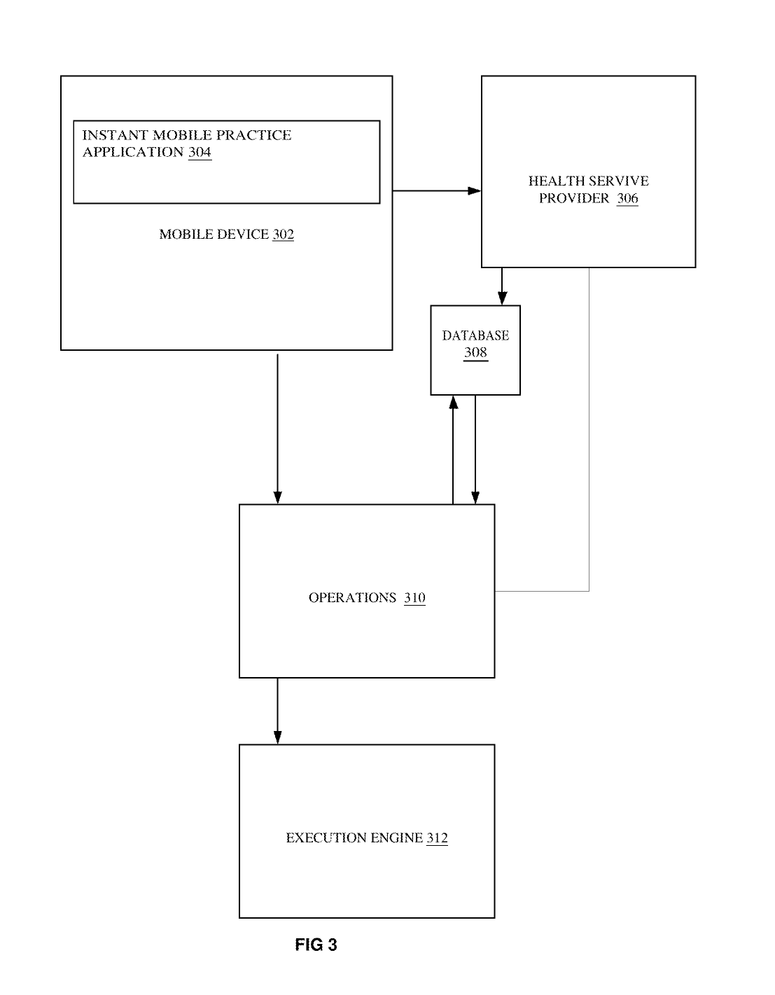

FIG. 3 is a system diagram showing an Instant Mobile Practice system. In one or more embodiments, an IMP system may include a mobile device 302, instant mobile practice application 304, health service provider 306, a database 308, operations module 310 and an execution engine 312 to perform operations chosen by a consumer.

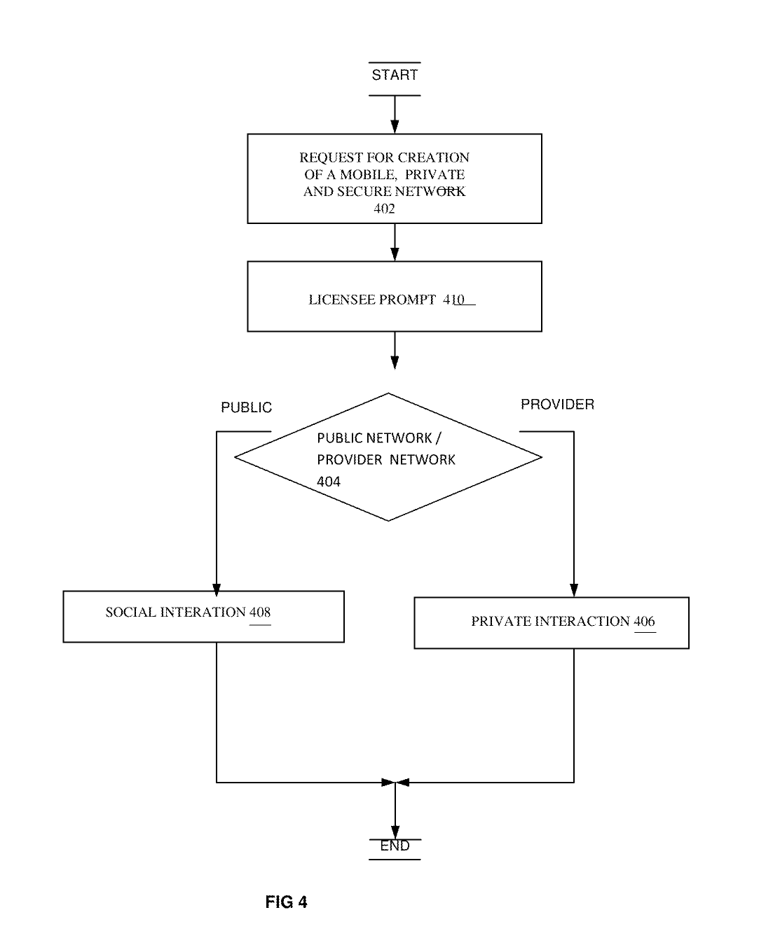

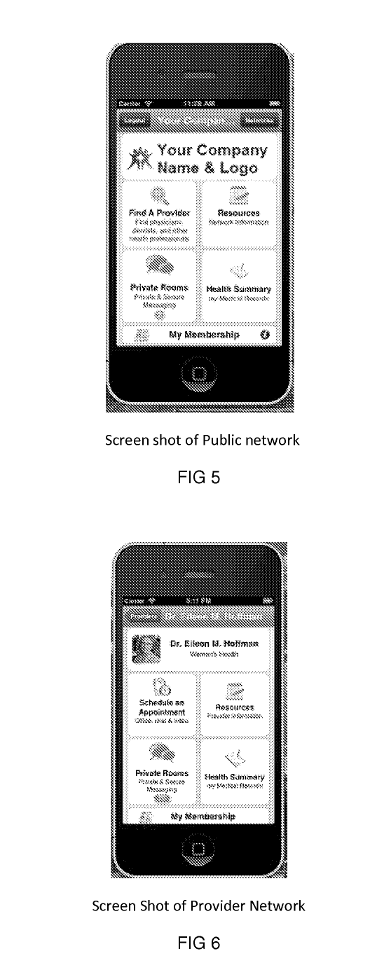

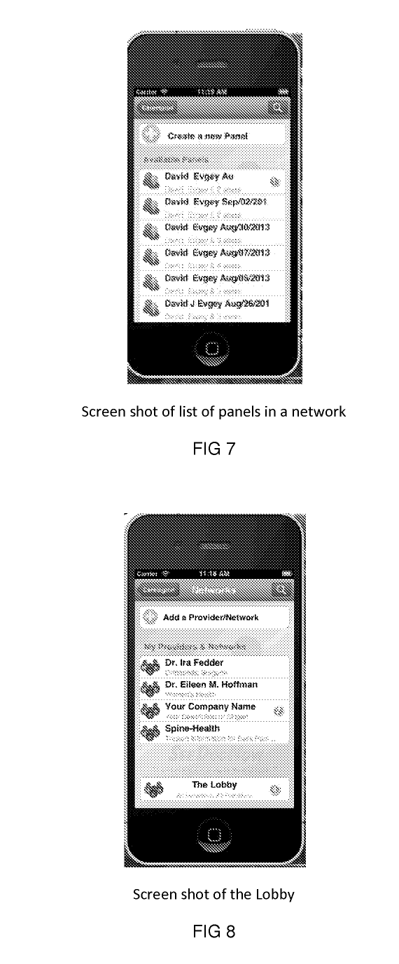

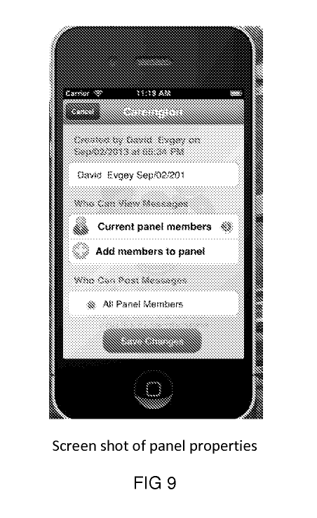

FIG. 4 is a flow diagram depicting an operation of an IMP system. On receiving a request for real time communication from a consumer 402, a consumer prompt 410 is shown to the consumer. The consumer may have to choose from a public and a provider network 404. Choice of public network may imply social interaction 408 and choice of the provider network may imply private interaction 406.

In an example embodiment, a user of a mobile device may request for real time communication with a network through a mobile application. For example, the mobile device may be an iPhone™ and the application may be an iPhone™ application. The network may be one of a public network and/or provider network. The mobile application may address health needs of the user. The health needs of the user may be included in the mobile application as features to be chosen from by the user. Further, the mobile application may include a lobby. The lobby may be an interaction facility through the mobile application.

In another example embodiment, a lobby may allow a user to interact with a network through one of messages, forums, video chat, and/or conference.

In one or more embodiments, a user of the IMP system may fill a single form to generate a code that allows registration onto a network. The network may be one of a public network and a private network.

In an example embodiment, the IMP system may create a health summary. Health summary may include details such as emergency contact details and health condition to be shared with a network. In one or more embodiments, health summary may be customized to a user.

In one or embodiments, a user of the IMP system may have access to a set of resources. The resources may include videos, articles, audio clips, and/or blogs. The resources may be searchable.

In one or more embodiments, a user may have access to a page that provides details about membership. In an example embodiment, the page may include details such as personal contact details furnished to IMP, date of joining IMP, date until membership is valid, and/or renewal information.

In an example embodiment, a patient as a user of IMP system may have to coordinate care and well-being with multiple providers, health insurance companies, home care companies, and the user's employer. The mobile application may provide patients with easy access to a provider or a group of health insurance companies, hospitals, nurses, home care companies and family members.

In an example embodiment, a provider network may be associated with supporting staff such as billing, scheduling referrals etc. Examples of provider networks are physicians, specialists, dentists, psychiatrists, psychologists, and other care givers.

In an example embodiment, an public networks may include health insurance companies, hospitals, inpatient and outpatient organizations, associations and other such care providers.

In an example embodiment, the Lobby in the mobile application may provide a list of new messages from providers and networks. The Lobby may save valuable time for user. A user may see all messages in an aggregated manner instead of visiting individual networks. Further, the user may contact an entity using the IMP system regardless of network affiliation.

In an example embodiment, a doctor and/or organization may fill a form with contact information including a list of contactable staff along with photographs and/or logo of the organization and other information. Further, the mobile application may create a private secure network and assign a pass code to the private secure network. By entering the pass code patients may add the private secure network to the list of available networks. Now the patient may contact the network and contacts associated with the network.

In an example embodiment, a user may add contacts onto the mobile application. The user may contact contacts in the mobile device, staff members of a network, all member of the network.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A method of a mobile device enabling communication for a health service provider comprising:
receiving a request from a licensee through the mobile device for the creation of a mobile private and secure network for real-time communication with a health service provider,
wherein the request is a form,
wherein the licensee is one of a health service organization, a provider and a patient;
prompting the Licensee to choose one of a public network and a provider network;
generating, by one or more computers, a choice of operations;
receiving from the consumer a choice among the choice of operations through the mobile device; and
performing a chosen operation based on the choice by the consumer.

2. A method of claim 1 further comprising:
wherein the choice of operations include at least one of scheduling an appointment, resource management, private communication, chat form to collect data from chats, creation of private and public network, and management of relationship between consumers.

3. The method claim 2 further comprising:
collecting a question and an answer from a chat room; and
associating the question with at least one of a serial number and user name

4. The method claim 1 further comprising:
creating the provider network under a brand name of one of the health service network and a provider,
wherein the provider network is exclusive of other networks.

5. The method claim 2 further comprising:
wherein resource management includes managing at least one of a list of links to videos, form data, surveys, and web content selected by the health service provider

6. The method claim 1 further comprising:
receiving the form to generate a code,
wherein the code provides access to at least one of the public network and the provider network.

7. The method claim 6 further comprising:
joining one of a public network and a provider network by entering a pass code;
upon validation of pass code:
subscribing the user to one of a public network and a provider network.

8. The method claim 1 further comprising:
generating a license for the consumer,
wherein the licensee holder chooses on a user interface one of collaboration between consumers and others consumers, and consumers and staff of one of the public network and the provider network.

9. The method claim 1 further comprising:
a Chatform technology presenting questions in chat ; collecting the data;
and saving that data to databases and to downloadable spreadsheet containing the results-answers; wherein ChatForm uses the “casual” nature of the chat for both open ended text and multiple choice questions.

10. The method claims 1 further comprising:
Enabling the user of the service to join Purchasing groups for buying medications, medical devices, and other health related services and products;
wherein IMP issues an SDN code which enables the user to purchase the product or service at a discounted price.
